(19) United States
(12) Patent Application Publication
(10) Pub. No.: US 2009/0231592 A1
(43) Pub. Date: Sep. 17, 2009

(54) REFRACTIVE SPATIAL HETERODYNE SPECTROMETER

(76) Inventors: John M. Harlander, St. Cloud, MN (US); Christoph R. Englert, Alexandria, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 12/049,947

(22) Filed: Mar. 17, 2008

(51) Int. Cl. G01J 3/45

(52) U.S. Cl. 356/456

(57) ABSTRACT

A refractive spatial heterodyne spectrometer includes an input aperture for receiving an input light; a collimating lens for collimating the input light into a collimated lightbeam; and a beamsplitter for reflecting one part of the collimated light into a first arm and transmitting another part of the collimated light into a second arm. The first arm includes a first dispersing prism for receiving and refracting the first part of the collimated light, and a first mirror positioned to reflect the refracted first collimated light back through the first dispersing prism and to the beamsplitter as a first light wavefront. The second arm includes a second dispersing prism for receiving and refracting the other part of the collimated light, and a second mirror positioned to reflect this refracted light back through the second dispersing prism and to the beamsplitter as a second light wavefront. The beamsplitter transmits a portion of the first light wavefront and reflects a portion of the second light wavefront into an output optics section to inferometrically combine into an interference image, and a detector receives the interference image and outputs an interference image pattern.

### BACKGROUND OF THE INVENTION

The present invention is directed to a spatial heterodyne spectrometer. More particularly, the invention is directed to a refractive spatial heterodyne spectrometer that employs a mirror and a dispersing prism in lieu of a diffraction grating in each arm.

Passive remote sensing is increasingly useful in myriad applications, including industrial, scientific, and military. Military applications include intelligence gathering, e.g. monitoring exhaust fumes to infer the nature and scope of industrial processes , tactical battlefield applications such as chemical threat identification, and tagging, tracking, and location efforts.

Spatial heterodyne spectroscopy (SHS), e.g. as described in U.S. Pat. No. 5,059,027, Roesler et al., issued Oct. 22, 1991, and incorporated herein by reference, has primarily been used for ultraviolet applications that require very high spectral resolution and a narrow passband. Recently, SHS has also been considered for applications that require moderate resolution, e.g. the SHIM-Fire breadboard instrument that has a passband in the near infrared (700 nm-900 nm) with a spectral resolution of 0.7 nm. In the future, SHS instruments with even lower resolution (resolving power of a few hundred) are planned e.g. for the remote detection of atmospheric gasses. The two main methods that are currently used for these moderate resolution applications are diffraction grating spectroscopy and conventional Fourier transform spectroscopy (FTS). Depending on the specific requirements of the application, SHS can be superior to the other methods. For instance, if the target is rapidly changing, FTS (but not SHS) is forced to scan rapidly in order not to confuse spectral and temporal information.

SHS is similar to a Michelson interferometer but the mirrors terminating the interferometer arms are replaced by fixed, tilted diffraction gratings. A basic SHS configuration 10 is illustrated in FIG. 1. An SHS spectrometer 100 includes input optics, an interferometer and output optics. The input optics include an input aperture 102, and collimating lens 104. The interferometer includes a beam splitter 106, prism 108, prism 110, grating 112, and grating 114. The output optics include focusing lens 116, collimating lens 118 and detector 120.

In operation, input light passes through input aperture 102 and diverges to collimating lens 104. Collimated light λ₁ includes an incident wave front 122. Collimated light λ₁ is then incident upon beam splitter 106. A first portion of collimated light λ₂ is reflected in a first arm 123 of spectrometer 100 toward prism 108, which is then refracted by an angle 124 toward grating 112. Grating 112 reflects light λ₃ back through prism 108 and toward beam splitter 106, where light λ₃ is partially reflected toward lens 104 and partially transmitted toward lens 116. The output optics portion is designed to image the grating planes 112 and 114 onto the detector 120. Here, the partially transmitted light λ₆ includes a wave front 128 and is focused by lens 116 to a point 134. The light λ₆ then diverges toward lens 118 to be imaged on detector 120. A second portion λ₄ of collimated light λ₁ is transmitted through beam splitter 106 in a second arm 129 of spectrometer 100 toward prism 110, which is then refracted by an angle 126 toward grating 114. Grating 114 reflects light λ₅ back through prism 110 and toward beam splitter 106, where light λ₁ is partially transmitted toward lens 104 and partially reflected toward lens 116. In the output optics portion, the partially reflected light λ₇ includes a wave front 130 and is focused by lens 116 to a point 134. The light λ₇ then diverges toward lens 118 to be imaged on detector 120.

Wave front 128 constructively and destructively interferes with wave front 130, such that that image detected by detector 120 is an interference pattern. An example of such an interference pattern for a monochromatic source is illustrated in FIG. 3. The characteristics of the pattern are based on the wavelength of the light λ₁ and the angle 132 between wave front 128 and wave front 130. Angle 132 is mainly based on the frequency of the input light λ₁ and the structure and angle of gratings 112 and 114. Field-widening prisms 106 and 108 are optional, and merely compensate for non-paraxial rays within the interferometer, in order to increase the throughput.

One limitation of moderate resolution SHS interferometers is the order overlap. In that case, the angular region covered by the signal within the passband and one order of grating diffraction overlaps with the angular region covered by an adjacent order. Once the orders overlap, the relation between the wavelength and angle g is not unique any longer and the unwanted orders will contaminate the resulting interferogram and spectrum, resulting in spurious fringes and/or increased noise. It is therefore desirable to provide an SHS interferometer without such limitations.

### BRIEF SUMMARY OF THE INVENTION

A refractive spatial heterodyne spectrometer includes an input aperture for receiving an input light; a collimating lens for collimating the input light into a collimated light; and a beamsplitter for reflecting one part of the collimated light into a first arm and transmitting another part of the collimated light into a second arm. The first arm includes a first dispersing prism for receiving and refracting the first part of the collimated light, and a first mirror positioned to reflect the refracted first collimated light back through the first dispersing prism and to the beamsplitter as a first light wavefront. The second arm includes a second dispersing prism for receiving and refracting the other part of the collimated light, and a second mirror positioned to reflect this refracted light back through the second dispersing prism and to the beamsplitter as a second light wavefront. The beamsplitter transmits a portion of the first light wavefront and reflects a portion of the second light wavefront into an output optics section to inferometrically combine into an interference image, and a detector receives the interference image and outputs an interference image pattern.

For moderate resolution applications, the throughput, and therefore the sensitivity, of prior SHS interferometer designs are limited by contamination from unwanted grating orders within the instrument passband. The invention avoids this limitation by employing refractive prisms in lieu of diffraction gratings since refractive prisms do not produce multiple orders. As a result the refractive SHS can achieve larger throughput and a larger spectral range in moderate or low resolution applications. The invention enables a smaller, lighter spectrometer, which is important for applications requiring minimal weight loadings, such as Unmanned Aerial Vehicles or other applications where the equipment has to be transported, e.g. by a warfighter for use in a battlefield environment. Its increased throughput provides higher sensitivity that provides faster threat recognition with lower false alarm rates.

### BRIEF DESCRIPTION OF THE DRAWINGS

FIG. 1 is a schematic diagram of a prior art SHS spectrometer;

FIG. 2 is a schematic diagram of an SHS spectrometer according to the invention; and

FIG. 3 is an interferogram of a monochromatic source measured by the near infrared SHIM-Fire SHS instrument.

### DETAILED DESCRIPTION OF THE INVENTION

Definitions: As used herein, the term “field-widening prism” means a wedged, refractive elements whose purpose is to increase the throughput of the system by reducing the path difference change between on and off-axis rays. Exemplary field-widening prisms include prisms typically manufactured from low-dispersion glass. As used herein, the term “dispersing prism” means a wedged, refractive element whose purpose is to make the angle of deviation of the beam a function of wavelength. Exemplary dispersing prisms include prisms typically manufactured from a high-dispersion glass.

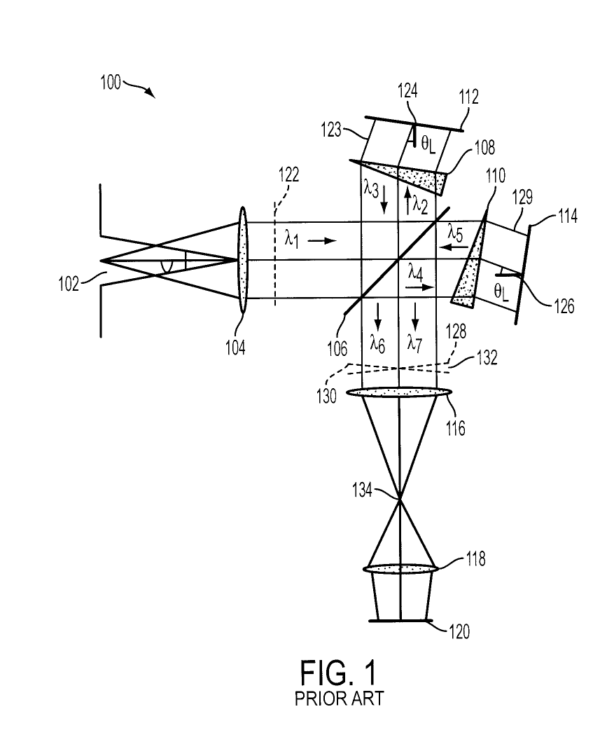

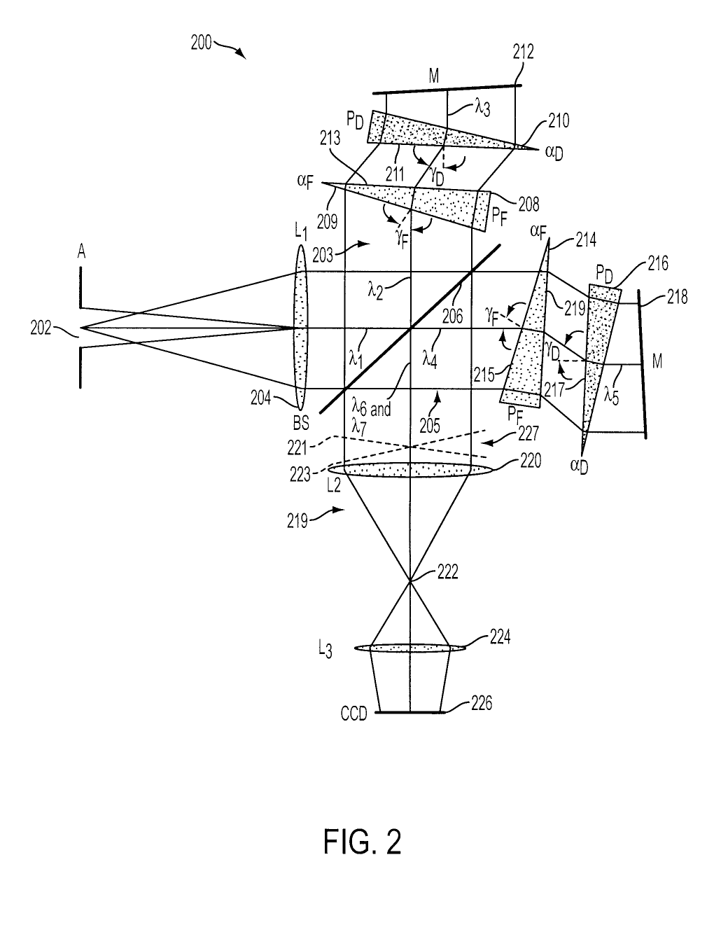

The invention is similar to the conventional SHS shown in FIG. 1 except that the diffraction gratings in each arm are replaced by a mirror and a dispersing prism. Additionally in order to obtain a large interferometer field of view a second low-dispersion field widening prism is preferably inserted in each arm. The combination of two prisms in each arm results in a system that has no contamination from unwanted grating orders while at the same time retaining the advantages of conventional SHS (small size, extremely sensitive and robust). Referring now to FIG. 2, an SHS spectrometer 200 according to the invention receives input light through input aperture 202 that diverges to collimating lens 204. Collimated light λ₁ is then incident upon beamsplitter 206 that in a first arm 203 reflects a first portion λ₂ to an optional low-dispersion field widening prism 208 at an angle γ_{F} with respect to the normal of its leading surface 209, which refracts it to a dispersing prism 210 at an angle γ_{D} with respect to the normal of its leading surface 211 that then refracts it to a mirror 212 positioned perpendicular to light of a particular wavelength incident on it. Mirror 212 is thereby positioned to reflect light λ₃ back through prisms 210 and 208 to beamsplitter 206.

In a second arm 205, a second portion λ₄ of collimated light λ₁ is transmitted through beamsplitter 206 toward a second optional low-dispersion field widening prism 214 also positioned at angle γ_{F} with respect to the normal of its leading surface 215, which refracts it to a second dispersing prism 216 also at angle γ_{D} with respect to the normal of its leading surface 217 that then refracts to a second mirror 218 positioned perpendicular to light of a particular wavelength incident on it. Mirror 218 is thereby positioned to reflect light λ₅ back through prisms 216 and 214 to beamsplitter 206.

Light λ₃ is partially reflected by beamsplitter 206 toward lens 204 and partially transmitted as λ₆ having a wavefront 221 into the output optics portion 219, and likewise light λ₅ is partially transmitted toward lens 204 and partially reflected as λ₇ having a wavefront 223 into the output optics portion where the wavefronts of λ₆ and λ₇ combine and are focused by lens 220 to a point 222. The light then diverges toward lens 224 to be imaged on detector 226, e.g. a CCD-based sensing system.

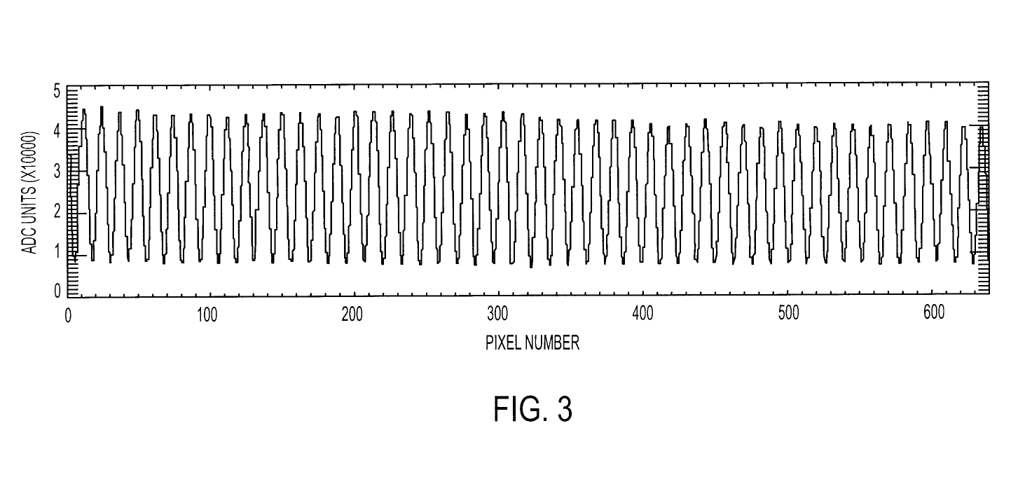

The output optics portion is designed to image the dispersing prism/mirror sections onto the detector 226. The two wave fronts λ₆ and λ₇ constructively and destructively interfere such that that image detected by detector 226 is an interference pattern. An example of such an interference pattern is illustrated in FIG. 3. The characteristics of the pattern are based on the wavelength of the light λ₁ and the angle 227 between the wave fronts. Angle 227 is mainly based on the frequency of the input light λ₁ and the optical properties and angle of the two prisms/mirrors. As discussed, the field-widening prisms 208 and 214 are optional, and merely compensate for non-paraxial rays within the interferometer, in order to increase the throughput.

Both the dispersing (P_{D}) and field-widening (P_{F}) prisms shown in FIG. 2 are oriented for minimum deviation at the Littrow wavelength. In this geometry the optical axis enters and leaves the prism symmetrically at angles γ_{D} and γ_{F}, respectively. The relationship between the angles of incidence and the prism apex angles (α_{D} and α_{F}) are:

n_{D} sin(α_{D}/2)=sin γ_{D}

n_{F} sin(α_{F}/2)=sin γ_{F}

Where subscript D refers to the high-dispersing, or simply dispersing, as the term is employed herein, prism, and F refers to the low-dispersing field-widening prism. The relationship determining the resolving power (R₀=λ/dλ where dλ is the minimum resolvable wavelength interval) of the all-refractive SHS is given by:

$${R}_{0} = 8 W [ tan {γ}_{D} \frac{1}{{n}_{D}} \frac{d {n}_{D}}{d λ} - tan {γ}_{F} \frac{1}{{n}_{F}} \frac{d {n}_{F}}{d λ} ]$$

Where W is the width of the beam in air.
The system achieves a wide field when the high and low dispersion prisms are oppositely oriented, as shown in FIG. 2 and the prism angles γ_{D} and γ_{F} are given by:

$$tan {γ}_{D} \frac{{n}_{D}^{2} - 1}{{n}_{D}^{2}} = tan {γ}_{F} \frac{{n}_{F}^{2} - 1}{{n}_{F}^{2}}$$

It is also important that the system achieve a large field of view over a moderately large wavelength range. This can be accomplished using the condition:

$$\frac{1}{{n}_{D} ( {n}_{D}^{2} - 1 )} \frac{d {n}_{D}}{d λ} = \frac{1}{{n}_{F} ( {n}_{F}^{2} - 1 )} \frac{d {n}_{F}}{d λ}$$

Where n_{D} and n_{F} are the refractive indices of the respective prism materials.

Obviously many modifications and variations of the present invention are possible in the light of the above teachings. It is therefore to be understood that the scope of the invention should be determined by referring to the following appended claims.

What is claimed as new and desired to be protected by Letters Patent of the United States is:

1. A spatial heterodyne spectrometer, comprising:
an input aperture for receiving an input light;
a collimating lens for collimating the input light into a collimated light;
a beamsplitter for reflecting a first portion of the collimated light into a first arm and transmitting a second portion of the collimated light into a second arm, wherein the first arm comprises:
a first dispersing prism for receiving and refracting the first collimated light portion; and
a first mirror positioned to reflect the refracted first collimated light portion back through the first dispersing prism and to the beamsplitter as a first arm light wavefront;
and wherein the second arm comprises:
a second dispersing prism for receiving and refracting the second collimated light portion; and
a second mirror positioned to reflect the refracted second collimated light portion back through the second dispersing prism and to the beamsplitter as a second arm light wavefront;
whereby the beamsplitter transmits a portion of the first arm light wavefront and reflects a portion of the second arm light wavefront into an output optics section so as to inferometrically combine into an interference image; and
a detector for receiving the interference image and outputting an interference image pattern.

2. A spectrometer as in claim 1, further comprising:
a first low-dispersion field widening prism positioned between the beamsplitter and the first dispersing prism; and
a second low-dispersion field widening prism positioned between the beamsplitter and the second dispersing prism.

3. A spectrometer as in claim 1, wherein the output optics section comprises:
a focusing lens for receiving the combined transmitted first arm light wavefront and reflected second arm light wavefront and forming a focused interference wavefront; and
an imaging lens for receiving the focused interference wavefront and forming the interference image.

4. A spectrometer as in claim 3, further comprising:
a first low-dispersion field widening prism positioned between the beamsplitter and the first dispersing prism; and
a second low-dispersion field widening prism positioned between the beamsplitter and the second dispersing prism.

5. A spectrometer as in claim 4, wherein each of the dispersing and field widening prisms in each arm are oppositely oriented and the prism angles are given by:
$$tan {γ}_{D} \frac{{n}_{D}^{2} - 1}{{n}_{D}^{2}} = tan {γ}_{F} \frac{{n}_{F}^{2} - 1}{{n}_{F}^{2}} ,$$
where γ_{D} and γ_{F} respectively are angles of an optical axis entering and leaving each respective dispersing and field widening prism and the relationship between the angles of incidence and the prism apex angles (α_{D} and α_{F}) are:
n_{D} sin(α_{D}/2)=sin γ_{D}
n_{F} sin(α_{f}/2)=sin γ_{F}

6. A method of obtaining an interferogram of a remote light source, comprising:
receiving the light source as an input light;
collimating the input light into a collimated light;
beamsplitting the collimated light into a first arm and a second arm with a beamsplitter;
in each of said arms, applying said beamsplitting collimated light to a dispersing prism, refracting said collimated light to a mirror, and reflecting the refracted light back through the dispersing prism on a return path to the beamsplitter; and
combining the refracted light from each said arm in an output optics section so as to inferometrically combine into an interferogram of the remote light source.

7. A method as in claim 6, further comprising interposing a field widening prism in each said arm between the beamsplitter and each said dispersing prism.

8. A method as in claim 7, wherein each arm includes a dispersing and a field widening prism that are oppositely oriented with the prism angles given by:
$$tan {γ}_{D} \frac{{n}_{D}^{2} - 1}{{n}_{D}^{2}} = tan {γ}_{F} \frac{{n}_{F}^{2} - 1}{{n}_{F}^{2}} ,$$
where γ_{D} and γ_{F} respectively are angles of an optical axis entering and leaving each respective dispersing and field widening prism and the relationship between the angles of incidence and the prism apex angles (α_{D} and α_{F}) are:
n_{D} sin(α_{D}/2)=sin γ_{D}
n_{F} sin(α_{F}/2)=sin γ_{F}

9. A spatial heterodyne spectrometer, comprising:
a means for receiving an input light;
a collimating means for collimating the input light into a collimated light;
a means for beamsplitting the collimated light and reflecting a first portion of the collimated light into a first arm and transmitting a second portion of the collimated light into a second arm, wherein the first arm comprises:
a first dispersing means for receiving and refracting the first collimated light portion; and
a reflecting means positioned to reflect the refracted first collimated light portion back through the first dispersing means and to the beamsplitting means as a first arm light wavefront;
and wherein the second arm comprises:
a second dispersing means for receiving and refracting the second collimated light portion; and
a second reflecting means positioned to reflect the refracted second collimated light portion back through the second dispersing means and to the beamsplitting means as a second arm light wavefront;
whereby the beamsplitting means transmits a portion of the first arm light wavefront and reflects a portion of the second arm light wavefront into an output optics processing means for inferometrically combining into an interference image; and
a detecting means for receiving the interference image and outputting an interference image pattern.

10. A spectrometer as in claim 9, further comprising:
a first low-dispersion field widening means positioned between the beamsplitting means and the first dispersing means; and
a second low-dispersion field widening means positioned between the beamsplitting means and the second dispersing means.

11. A spectrometer as in claim 9, wherein the output optics processing means comprises:
a focusing means for receiving the combined transmitted first arm light wavefront and reflected second arm light wavefront and forming a focused interference wavefront; and
an imaging means for receiving the focused interference wavefront and forming the interference image.

12. A spectrometer as in claim 11, further comprising:
a first field widening means positioned between the beamsplitting means and the first dispersing means; and
a second field widening means positioned between the beamsplitting means and the second dispersing means.

13. A spectrometer as in claim 12, wherein each of the dispersing and field widening means in each arm are oppositely oriented and the prism angles are given by:
$$tan {γ}_{D} \frac{{n}_{D}^{2} - 1}{{n}_{D}^{2}} = tan {γ}_{F} \frac{{n}_{F}^{2} - 1}{{n}_{F}^{2}} ,$$
where γ_{D} and γ_{F} respectively are angles of an optical axis entering and leaving each respective dispersing and field widening means and the relationship between the angles of incidence and the prism apex angles (α_{D} and α_{F}) are:
n_{D} sin(α_{D}/2)=sin γ_{D}
n_{F} sin(α_{F}/2)=sin γ_{F}.
